(19) United States
(12) Patent Application Publication
(10) Pub. No.: US 2011/0240895 A1
(43) Pub. Date: Oct. 6, 2011

(54) SOLENOID SPOOL VALVE

(75) Inventor: Hiroshi YASOSHIMA, Kariya-city (JP)

(73) Assignee: DENSO CORPORATION, Kariya-city (JP)

(21) Appl. No.: 13/076,817

(22) Filed: Mar. 31, 2011

(30) Foreign Application Priority Data
Apr. 1, 2010 (JP) 2010-85032

(51) Int. Cl. F16K 31/02

(52) U.S. Cl. 251/129.15

(57) ABSTRACT

A solenoid spool valve includes a sleeve and a spool. The spool is received within the sleeve displaceably along a longitudinal axis to control a communication state of an input port, an output port, and a drain port of the sleeve. The sleeve includes an inner sleeve and an outer sleeve. The outer sleeve is fluid-tightly fitted with an outer peripheral surface of the inner sleeve. A feed-back chamber is defined at one axial end of the spool along the longitudinal axis, the feed-back chamber being communicated with the output port such that pressure of fluid in the output port is applied, as feed-back pressure, to the one axial end of the spool.

### CROSS REFERENCE TO RELATED APPLICATION

This application is based on and incorporates herein by reference Japanese Patent Application No. 2010-85032 filed on Apr. 1, 2010.

### BACKGROUND OF THE INVENTION

1. Field of the Invention

The present invention relates to a solenoid spool valve for driving a spool valve by an electromagnetic actuator.

2. Description of Related Art

JP-A-2009-275841 describes a conventional solenoid spool valve that is employed in an oil pressure control device for an automatic transmission of an automobile.

As shown in FIG. 2, a solenoid spool valve 100 includes an electromagnetic actuator 101 and a spool valve 102. The spool valve 102 includes a sleeve 109 and a spool 110. The sleeve 109 has an input port 103, an output port 104, and a drain port 105. The spool 110 controls a communication state of each port when the spool 110 displaces within the sleeve 109 in an axial direction.

Thrust force, which is generated by the electromagnetic actuator 101, is transmitted to the spool 110, and thereby the spool 110 is displaced in the axial direction.

Also, the solenoid spool valve 100 includes a feed-back chamber 112, which is communicated with the output port 104. Thus, the feed-back chamber 112 applies pressure of fluid, which is in the output port 104, back to the spool 110.

Due to the above, the spool 110 receives an application force against the thrust force. The application force applied to the spool 100 includes biasing force of a spring 113 and pressure in the feed-back chamber 112. When (a) thrust force and (b) biasing force from the spring 113 and the feed-back chamber 112 are balanced, the spool 110 stops displacement.

The conventional feed-back chamber 112 is defined between lands 114, 115 having different diameters. The feed-back chamber 112 is formed at a position away from one axial end toward the other end of the spool 110. Feed-back pressure is applied to the spool 110 by using difference in the diameters of the land 114 and the land 115.

However, in the configuration of the feed-back chamber 112, because it is required to provide a feed-back port 117 to the sleeve 109, an axial dimension of the spool valve 102 becomes long due to the increase of the number of ports disadvantageously.

Also, in the solenoid spool valve 100, the spool valve 102 is received within an insertion hole 119 of a fixing object 118, to which the spool valve 102 is fixed. In the above, it is required to seal the gaps formed between the ports in order to avoid the unwanted communication between the ports through the clearance between the sleeve 109 and the insertion hole 119.

For example, a seal member (for example, O-ring) is provided on an outer periphery of the sleeve 109 in one conventional sealing method. In the other method, a clearance sealing is formed between the outer peripheral surface of the sleeve 109 and the inner peripheral surface of the insertion hole 119.

However, in order to provide the above sealing methods, the dimension between the ports has to be longer than a predetermined distance that is required for substantial sealing performance. As a result, the axial dimension of the spool valve 102 becomes long unwantedly.

For example, an opening 121 of the output port 104 is provided between, in the axial direction, (a) an opening 122 of the input port 103 and (b) an opening 123 of the drain port 105. Also, the opening 121 of the output port 104 opens to the outer peripheral surface of the sleeve 109. As a result, in order to seal the clearance between the input port 103 and the output port 104, and to seal the clearance between the output port 104 and the drain port 105, the axial distance between the input port 103 and the output port 104, and the other axial distance between the output port 104 and the drain port 105 have to be longer than the predetermined distance, which is required for achieving substantial sealing performance. As a result, the axial distance between the input port 103 and the drain port 105 becomes longer, and the axial dimension of the spool valve 102 becomes longer.

### SUMMARY OF THE INVENTION

The present invention is made in view of the above disadvantages. Thus, it is an objective of the present invention to address at least one of the above disadvantages.

To achieve the objective of the present invention, there is provided a solenoid spool valve that includes a sleeve (5) and a spool. The sleeve has an input port, an output port, and a drain port. The spool is received within the sleeve displaceably along a longitudinal axis to control a communication state of the input port, the output port, and the drain port. The sleeve includes an inner sleeve and an outer sleeve. The outer sleeve is fluid-tightly fitted with an outer peripheral surface of the inner sleeve. The input port and the drain port open at an outer peripheral surface of the sleeve. The output port includes an inlet-side opening, an outlet-side opening, and a communication passage. The inlet-side opening opens at the inner sleeve. The outlet-side opening opens at one axial end of the sleeve along the longitudinal axis. The communication passage is defined between the inner sleeve and the outer sleeve to provide communication between the inlet-side opening and the outlet-side opening. A feed-back chamber is defined at one axial end of the spool along the longitudinal axis. The feed-back chamber is communicated with the output port such that pressure of fluid in the output port is applied, as feed-back pressure, to the one axial end of the spool.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view of a solenoid spool valve according to one embodiment of the present invention; and

FIG. 2 is a cross-sectional view of a solenoid spool valve according to a conventional art.

### DETAILED DESCRIPTION OF EMBODIMENTS

### Embodiment

### (Configuration of Embodiment)

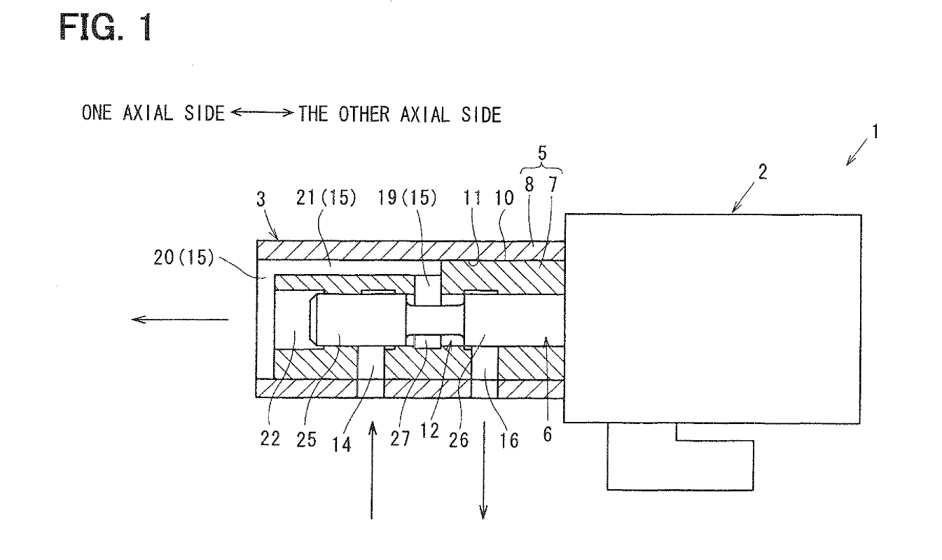

A configuration of a solenoid spool valve 1 of one embodiment of the present invention will be described with reference to FIG. 1.

The solenoid spool valve 1 is employed for hydraulic control in an oil pressure control device, such as an automatic transmission of an automobile, and includes an electromagnetic actuator 2 and a spool valve 3.

The spool valve 3 includes a sleeve 5 and a spool 6. The sleeve 5 includes multiple fluid ports (described later) that are communicated with multiple external flow channels. The spool 6 is received within the sleeve 5 displaceably in an axial direction of the spool 6 (or along a longitudinal axis of the spool 6) to control a communication state of the fluid ports. In the present embodiment, when the communication state of the fluid ports are controlled, the communication between the fluid ports is selectively disabled and enabled as required, for example.

The electromagnetic actuator 2 generates a thrust force that works to displace the spool 6 in the axial direction, and the thrust force is transmitted to the spool 6 through a shaft (not shown).

The sleeve 5 has a hollow cylindrical shape, and includes an inner sleeve 7 and an outer sleeve 8 that is provided at an outer periphery of the inner sleeve 7.

The inner sleeve 7 is pushed into the outer sleeve 8 such that a clearance between (a) an outer peripheral surface 10 of the inner sleeve 7 and (b) an inner peripheral surface 11 of the outer sleeve 8 is fluid-tightly sealed.

It should be noted that one axial ends of the inner sleeve 7 and the outer sleeve 8 open, and that the one axial end of the outer sleeve 8 further projects from the one axial end of the inner sleeve 7 in the direction away from the electromagnetic actuator 2. In the present embodiment, the one axial ends of the inner sleeve 7 and the outer sleeve 8 are located at positions away from the electromagnetic actuator 2 along the longitudinal axis of the sleeve 7 (left side in FIG. 1). The other axial ends of the inner sleeve 7 and the outer sleeve 8 are located at positions opposite from the one axial ends thereof and adjacent the electromagnetic actuator 2 along the longitudinal axis (right side in FIG. 1). In FIG. 1, one axial side corresponds to the left side, and the other axial side corresponds to the right side.

The sleeve 5 is provided with at least one input port 14, at least one output port 15, and at least one drain port 16 that are communicated with an interior (or a valve chamber 12) of the inner sleeve 7.

The input port 14 and the drain port 16 are provided to extend through walls of the inner sleeve 7 and the outer sleeve 8 in a radial direction.

The output port 15 includes an inlet-side opening 19, an outlet-side opening 20, and a communication passage 21. The inlet-side opening 19 extends through a peripheral wall of the inner sleeve 7 to open at the inner sleeve 7. In other words, the inlet-side opening 19 is an opening end of the output port 15 adjacent the valve chamber 12. The outlet-side opening 20 opens at the one axial end of the sleeve 5. The communication passage 21 is formed between the inner sleeve 7 and the outer sleeve 8 to communicate the inlet-side opening 19 with the outlet-side opening 20.

The communication passage 21 is a groove, which is formed on the outer peripheral surface 10 of the inner sleeve 7 to extend toward the one axial end of the inner sleeve 7, and which is communicated with the inlet-side opening 19.

Due to the above, fluid (or output fluid) in the output port 15 flows toward the opening at the one axial end of the outer sleeve 8 from the inlet-side opening 19 to the communication passage 21. in other words, fluid in the output port 15 flows toward the outlet-side opening 20. As a result, fluid in the output port 15 is supplied to the external flow channel through the outlet-side opening 20.

Also, as described above, the valve chamber 12 is communicated with the input port 14, the output port 15, the drain port 16 that are arranged in this order from the one axial end to the other end of the inner sleeve 7 in the axial direction.

It should be noted that a clearance between (a) the outer peripheral surface 10 of the inner sleeve 7 and (b) the inner peripheral surface 11 of the outer sleeve 8 is fluid-tightly sealed. Thereby, even in a case, where the communication passage 21 is provided between the inner sleeve 7 and the outer sleeve 8, fluid flowing through the communication passage 21 is prevented from leaking into the input port 14 or to the drain port 16 through the clearance formed between (a) the outer peripheral surface 10 of the inner sleeve 7 and (b) the inner peripheral surface 11 of the outer sleeve 8. Also, fluid in the input port 14 or in the drain port 16 is prevented from leaking into the communication passage 21.

Also, the solenoid spool valve 1 defines therein a feed-back chamber 22 that is located at the one axial end of the spool 6 to be communicated with the output port 15. The feed-back chamber 22 applies pressure of the output fluid to the one axial end of the spool 6 as feed-back pressure such that the spool 6 is displaceable in a direction away from the outlet-side opening 20.

In the present embodiment, the one axial end of the inner sleeve 7 opens. Also, a space, which is defined by (a) the inner peripheral surface of the one axial end portion of the inner sleeve 7 and (b) one end surface of the spool 6 received by the inner sleeve 7, constitutes the feed-back chamber 22, and is communicated with the output port 15. In the above, the one end surface of the spool 6 corresponds to an end surface of the one axial end of the spool 6.

The spool 6 includes multiple lands 25, 26 (two lands in the present embodiment) that slidably contact the inner peripheral surface of the inner sleeve 7. The land 25 has the diameter similar to the diameter of the land 26. In other words, each of the lands 25, 26 has the diameter similar to each other. The lands 25, 26 have diameters that are generally coincides with an inner diameter of the inner sleeve 7.

The land 25 adjusts the opening degree of the input port 14, and the land 26 adjusts the opening degree of the drain port 16. The land 25 and the land 26 defines therebetween a distribution chamber 27 that is communicated with the output port 15.

It should be noted that the spool 6 is urged by a spring (not shown) toward the other axial end (or in a direction away from the feed-back chamber 22).

### (Operation of Solenoid Spool Valve 1)

Operation of the solenoid spool valve 1 of the present embodiment will be described.

When thrust force toward the one axial end, which force is generated by the electromagnetic actuator 2, is transmitted to the spool 6 through the shaft (not shown), the spool 6 is displaced toward the one axial end against biasing force of the spring.

The land 25 opens the input port 14 with the displacement of the spool 6. As the land 25 opens the input port 14, fluid flows into the distribution chamber 27 through the input port 14. Then, fluid flows into the output port 15 from the distribution chamber 27. Due to the above, fluid flows into the feed-back chamber 22, and thereby pressure of fluid is applied to the one axial end of the spool 6 as feed-back pressure.

The spool 6 stops displacement at a position, at which resultant force of feed-back pressure and biasing force of the spring is balanced with the thrust force transmitted to the spool 6. For example, the resultant force is applied to the spool 6 in the direction toward the other axial end of the spool 6 (or in the direction away from the fee-back chamber 22). Also, the thrust force is applied to the spool 6 toward the one axial end of the spool 6 (or in the direction toward the feed-back chamber 22).

### (Advantages of Embodiment)

In the solenoid spool valve 1 of the present embodiment, the sleeve 5 includes the inner sleeve 7 and the outer sleeve 8 that is fluid-tightly fitted with the outer peripheral surface 10 of the inner sleeve 7.

Also, the input port 14 and the drain port 16 are provided to open at the outer peripheral surface of the sleeve 5. The output port 15 includes the inlet-side opening 19, the outlet-side opening 20, and the communication passage 21. The inlet-side opening 19 opens at the inner sleeve 7. The outlet-side opening 20 opens at the one axial end of the sleeve 5. The communication passage 21 is provided between the inner sleeve 7 and the outer sleeve 8 to provide communication between the inlet-side opening 19 and the outlet-side opening 20.

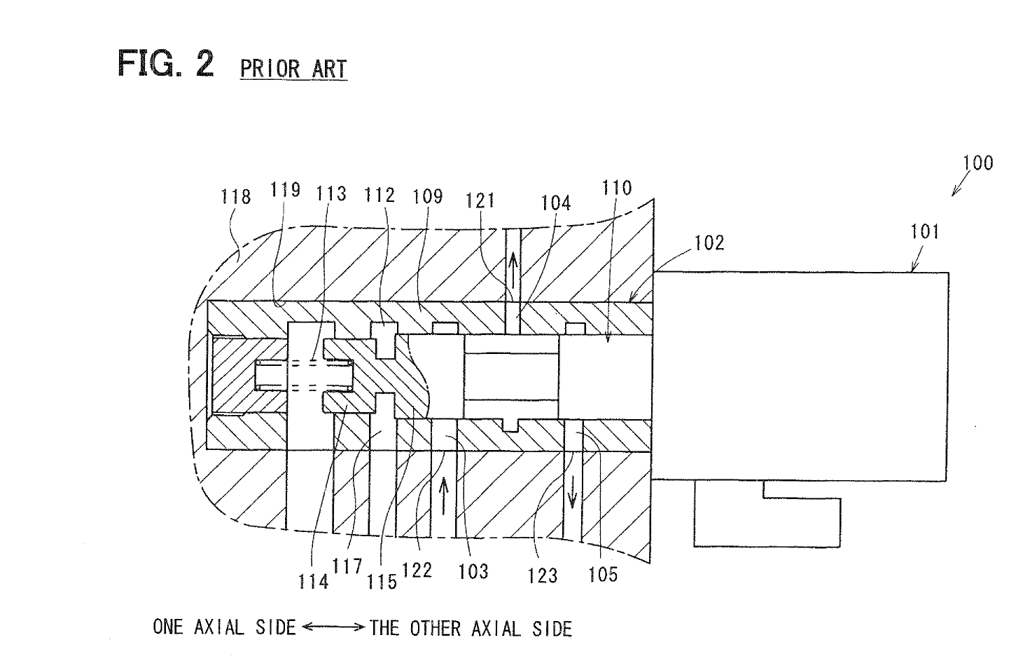

Due to the above, the outlet-side opening 20 of the output port 15 is located at the one axial end of the sleeve 5, and thereby the present embodiment of FIG. 1 is different from the conventional configuration of FIG. 2, in which the output port 104 is provided between the input port 103 and the drain port 105 in the axial direction.

As a result, it is possible to shorten (a) an axial distance between the input port 14 and the output port 15, which distance is measured in the axial direction, and (b) another axial distance measured between the output port 15 and the drain port 16 compared with the conventional technique. As a result, it is possible to shorten an axial distance measured between the input port 14 and the drain port 16. Due to the above, it is possible to shorten an axial dimension of the solenoid spool valve 1, which dimension is measured in the axial direction.

Also, the feed-back chamber 22, which is communicated with the output port 15, is defined at the one axial end of the spool 6, and the feed-back chamber 22 applies pressure of output fluid to the one axial end of the spool 6 as feed-back pressure. As a result, the feed-back port of the conventional art is not required in the present embodiment, and thereby it is possible to effectively reduce the number of the ports. As a result, it is possible to shorten the axial dimension of the solenoid spool valve 1.

Because the feed-back chamber 22 is provided at the one axial end of the spool 6, the one axial end of the spool 6 receives feed-back pressure, and thereby the spool 6 is displaceable by the feed-back pressure toward the actuator 2 against the thrust force generated by the actuator 2. As a result, it is not required to use the difference in diameters of the lands, which is required in the conventional art, in order to apply feed-back pressure to the spool 6 to displace the spool 6 toward the actuator 2. Thus, it is possible to uniform the diameters of all the multiple lands 25, 26.

Due to the above, it is possible to facilitate the machining of the spool 6, and the machining of the inner peripheral surface of the inner sleeve 7, on which the spool 6 slides. Also, it is possible to effectively reduce the clearance between the spool 6 and the sleeve 5 compared with the conventional case of FIG. 2, where the diameters of the lands vary, and thereby the clearance between the spool 110 and the sleeve 109 is sufficiently required for the fitting between the spool 110 and the sleeve 109. As a result, it is possible to reduce the consumption amount of flow.

Also, a land has a minimum diameter, which is physically or practically machinable. In the conventional art, a small land (corresponding to the land 114 in FIG. 2) is required in order to provide the difference in diameters of the lands. As a result, when the small land has the minimum diameter, other lands have to have diameters greater than the minimum diameter. Thereby, the diameter of the solenoid spool valve is inevitably enlarged.

However, in the solenoid spool valve 1 of the present embodiment, it is possible to uniform the diameter of the lands, and thereby it is possible to minimize the diameters of all of the lands. As a result, it is possible to reduce the diameter of the spool 6, and thereby it is possible to reduce the diameter of the solenoid spool valve 1.

### (Modification)

The solenoid spool valve 1 of the present invention is not limited to the above embodiment, and thereby the present invention is applicable to various modifications. For example, in the above embodiment, the groove is provided to the outer peripheral surface 10 of the inner sleeve 7 to define the communication passage 21 between the inner sleeve 7 and the outer sleeve 8. However, the groove may be alternatively provided to the inner peripheral surface 11 of the outer sleeve 8.

Also, in the above embodiment, the inner sleeve 7 is press-fitted into the outer sleeve 8. However, the method of assembling the outer sleeve 8 with the inner sleeve 7 is not limited to the press fitting provided that the clearance between the outer peripheral surface 10 of the inner sleeve 7 and the inner peripheral surface 11 of the outer sleeve 8 is fluid-tightly sealed.

Additional advantages and modifications will readily occur to those skilled in the art. The invention in its broader terms is therefore not limited to the specific details, representative apparatus, and illustrative examples shown and described.

What is claimed is:

1. A solenoid spool valve comprising:
a sleeve having an input port, an output port, and a drain port; and
a spool that is received within the sleeve displaceably along a longitudinal axis to control a communication state of the input port, the output port, and the drain port, wherein:
the sleeve includes:
an inner sleeve; and
an outer sleeve that is fluid-tightly fitted with an outer peripheral surface of the inner sleeve;
the input port and the drain port open at an outer peripheral surface of the sleeve;
the output port includes:
an inlet-side opening that opens at the inner sleeve;
an outlet-side opening that opens at one axial end of the sleeve along the longitudinal axis; and
a communication passage that is defined between the inner sleeve and the outer sleeve to provide communication between the inlet-side opening and the outlet-side opening; and
a feed-back chamber is defined at one axial end of the spool along the longitudinal axis, the feed-back chamber being communicated with the output port such that pressure of fluid in the output port is applied, as feed-back pressure, to the one axial end of the spool.

2. The solenoid spool valve according to claim 1, wherein:
the spool has a plurality of lands that is in slide contact with the sleeve, each of the plurality of lands having a diameter similar to each other.

3. The solenoid spool valve according to claim 1, wherein:
the feed-back chamber is defined by an inner peripheral surface of the inner sleeve and an end surface of the one axial end of the spool; and
pressure in the feed-back chamber is applied to the one axial end of the spool to displace the spool in a direction away from the outlet-side opening.
